(19) United States
(12) Patent Application Publication
(10) Pub. No.: US 2010/0125888 A1
(43) Pub. Date: May 20, 2010

(54) Systems and Methods for Providing Distributed Television Services to a Subscriber

(75) Inventor: Simon C.M. Jerram, Keighley (GB)

Correspondence Address: DORSEY & WHITNEY LLP;on behalf of EchoStar Technologies, L.L.C., 370 Seventeenth St., Suite 4700, Denver, CO, 80202-5647, US

(73) Assignee: Eldon Technology Limited, Keighley (GB)

(21) Appl. No.: 12/275,058

(22) Filed: Nov. 20, 2008

(51) Int. Cl. H04N 7/173

(52) U.S. Cl. 725/116

(57) ABSTRACT

Systems and methods may provide television services to a subscriber without relying on coaxial cable for distributing television signals throughout the subscriber's building. Instead, various systems and methods may provide a distributed television system in which a hub or central television receiving device is configured to receive television signals from a source and to provide the received television signals to a plurality of television output devices networked to the central television receiving device.

### TECHNICAL FIELD

The inventive field relates generally to providing television services to subscribers, such as via satellite, cable, antenna or the like. More particularly, the inventive field relates to providing distributed television services, such as for a residence or other establishment with multiple television output devices.

### BACKGROUND DISCUSSION

The proliferation of subscription television programming, the increasing number of available channels, and the corresponding increase in television programming have led to continued expansion of this industry. Individuals, families and business establishments desiring television services may select to subscribe to one of a variety of satellite and/or cable providers that generally provide a greater number of channels and higher quality signals for the users' enjoyment than may be accessed off-air with an antenna.

Regardless of the source of television services, subscription television service providers typically provide services to subscribers based on individual locations on an account basis. Each individual location or account may be a single family residence, a business establishment, or any other building, for example. As illustrated in FIG. 1, a subscriber 102 may include a plurality of televisions (TV) 120 or other television output devices, such as monitors and the like. Each television 120 may be provided with a television receiving device 100, which may be any suitable television receiver, tuner or the like that is configured to receive television signals via a connection 110. Connection 110 typically may comprise a wired connection, such as coaxial cable, that connects each television receiving device 100, either directly or indirectly, to a source of television programming, whether digital or analog, such as a satellite television distributor 104, a broadcast television provider 114 and/or a cable television distributor 116.

In the case of the cable television distributor 116, coaxial cabling, optical fibers or the like may run directly from the distributor 116 to the subscriber 102 where the coaxial cabling running through the walls of the building, for example, terminate in a wall outlet in individual rooms to provide the connection 110 to the individual television receiver devices 100. In the case of the satellite television distributor 104, television signals may be transmitted by the distributor 104 via a satellite 106, which then transmits the television signals to be received by a satellite communication device 108, such as a satellite dish. Again, the received television signals may be provided to the individual television receiving devices 100 via the connection 110, such as cabling through the walls of the building. In either case, television signals for local channels may be transmitted from the broadcast television provider 114 and received at the subscriber 102 via an over-the-air antenna 112, which also may be connected to the connection 110 to provide the received television signals to the individual television receiving devices 100. Also, particularly for satellite television services, a backchannel, such as a phone line connection, may also be provided to the television receiving devices 100, for example, to allow additional information other than television signals to be transmitted to the television receiving devices 100, such as programming guide information, software updates, and the like.

As well known in the art, each of the television receiving devices 100 may be configured to tune in different channels of television programming, either directly or by being controlled via an associated remote control device 126. Thus, different television signals may be selected at each respective television receiving device 100 so that different television programming may be watched on the corresponding televisions 120. Although the television receiving devices 100 and the televisions 120 are illustrated in FIG. 1 as two distinct elements, it should be understood that other configurations are possible in which the two elements are combined in whole or in part, such as a television with an integrated tuner, or in which any desired number of elements may be involved. As such, FIG. 1 is only an example to understand the context of the present disclosure.

Further, although the subscriber 102 is shown as receiving television signals from all three sources 104, 114, 116, it should be understood that a subscriber may in practice only receive television signals from one of the satellite television distributor 104 and the cable television distributor 116, with or without receiving television signals from the broadcast television provider 114. For example, as illustrated in FIG. 1, a subscriber 130 may only have a satellite communication device 134, such as a satellite dish, that receives television signals from the satellite television distributor 104 via the satellite 106, and provides the television signals to a television receiving device 132. Again, the television programming that is output via a television 138 associated with the television receiving device 132 may be selected by controlling the television receiving device 132, for example, via a remote control device 136.

Because such systems for providing television services to subscribers are well known in the art and may be implemented in various configurations, the details of such systems are not discussed further for the sake of brevity.

### SUMMARY

As discussed above, systems for providing television services to subscribers are generally well known. However, most conventional systems rely on the addition of some form of dedicated cabling to be run throughout the building to each individual rooms in which television receiver devices/televisions may be used. Thus, either at the time of construction of the building or at the time of installation of the system for receiving subscription television services, cabling must be run. At the time of construction, this requires foresight that subscription television services will be desired, foresight as to in which rooms television service will be desired, and foresight as to the technology that will be required. Thus, cabling at the time of construction involves investment cost and may involve overinvestment or wasted investment, for example, if less rooms utilize the cabling or technology changes. At the time of installation of the system for receiving subscription television services, the costs of running cabling may be substantially greater, for example, due to complexity of dealing with completed construction and/or due to repair of damage from installing cabling. Further, once the system is installed, the subscriber may be constrained to the cabling configuration, unless the subscriber is willing to incur the inconvenience and cost of rewiring.

Various systems and methods for providing television services to a subscriber described herein do not rely on dedicated cabling for distributing television signals throughout the subscriber's building. Instead, various systems and methods described herein involve providing a distributed television system in which a hub or central television receiving device is configured to receive television signals from a source and to provide the received television signals to a plurality of television output devices. The central television receiving device may be configured to provide the television signals directly to the television output devices or indirectly via a television interface device, for example, that is configured to interact with the central television receiving device.

In either case, the central television receiving device may be networked to the television output devices and/or television interface devices. Any suitable networking may be employed, such as a local area network, whether wired or wireless. In the case of wired, any suitable wiring may be employed, such as Ethernet, telephone and/or power. Such wiring is typically preexisting and/or provided to every room of a building, particularly those in which television viewing may possibly occur. Thus, no additional wiring would be needed for most, if not all, circumstances, whether new construction or existing buildings. In the case of wireless, any suitable wireless transmission technology may be employed, such as is well known in wireless computing and/or cellular telephone communications. Thus, no wiring may be required beyond any between the distributor and/or the intermediate communication device and the central television receiving device, which may or may not be needed or desired.

Thus, various embodiments relate to systems and methods that provide improved distribution of television services to a subscriber. In particular, various embodiments provide distributed television signals via a hub or central television receiving device. In embodiments, the central television receiving device may be networked with a plurality of television output devices to provide selective output of television signals received by the central television receiving device.

Various embodiments may provide wired or wireless networking of television output devices and/or television interface devices with the central television receiving device. Thus, various embodiments may provide substantial flexibility and reconfigurability for distribution of television signals within a subscriber's system.

In one embodiment, a system may provide distributed television service to a subscriber. The system may include: a central television receiving device configured to selectively receive television signals to be distributed to a plurality of television output devices; and a networking device configured to interface the central television receiving device with the plurality of television output devices. In some embodiments, the central television receiving device may include a plurality of tuners, each of the plurality of tuners configured to be controlled based on signals received via the networking device.

In another embodiment, a central television receiving device may provide distributed television service to a subscriber. The device may include: a plurality of tuners configured to selectively receive television signals; a processor configured to control the plurality of tuners; and a networking device configured to interface the plurality of tuners with a plurality of television output devices. In some embodiments, the plurality of tuners may be configured to be controlled based on signals received via the networking device.

In another embodiment, a method may provide distributed television service to a subscriber. The method may include: receiving television signals at a central television receiving device; assigning a first of a plurality of tuners of the central television receiving device to a corresponding one of a plurality of television output devices networked to the central television receiving device; and selectively receiving and transmitting television signals received at the central television receiving device via the assigned first tuner to the corresponding television output device. In some embodiments, assigning of the first tuner to the corresponding television output device may be based on a request by the corresponding television output device to tune in a television signal.

In various embodiments, the tuner(s) may comprise one or more satellite tuners for communicating with one or more satellite dishes, one or more cable tuners for communicating with one or more cable devices, and/or one or more over-the-air tuners for communicating with one or more antennas.

### BRIEF DESCRIPTION OF THE DRAWINGS

Various details of the present invention may be better understood on reading the following detailed description of non-limiting embodiments, and on examining the accompanying drawings, in which:

FIG. 1 is a schematic block diagram illustrating general configurations for providing television services.

FIG. 2 is a schematic block diagram illustrating an example of a configuration of a system for providing distributed television services to a subscriber.

FIG. 3 is a block diagram illustrating an example of a central television receiving device for providing distributed television services to a subscriber.

FIG. 4 is a block diagram illustrating an example of a television interface device for interacting with the central television receiving device of FIG. 3.

FIG. 5 is a flowchart illustrating an example of operations for providing distributed television services to a subscriber.

### DETAILED DESCRIPTION OF EMBODIMENTS

The embodiments shown in the Figures illustrate systems and methods that may provide distributed television service to a subscriber. The illustrated systems and methods provide examples of how a distributed television system and control thereof may be implemented. However, it should be understood that other implementations are possible and contemplated. Also, it should be understood that reference herein to a distributed television service and a distributed television system is distinguished from distribution of television signals to a plurality of subscribers as is generally understood as broadcast distribution.

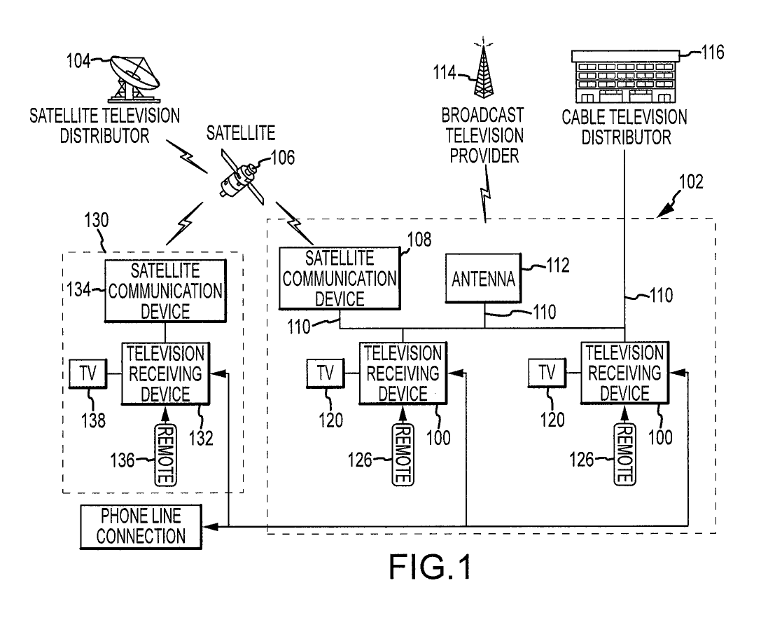

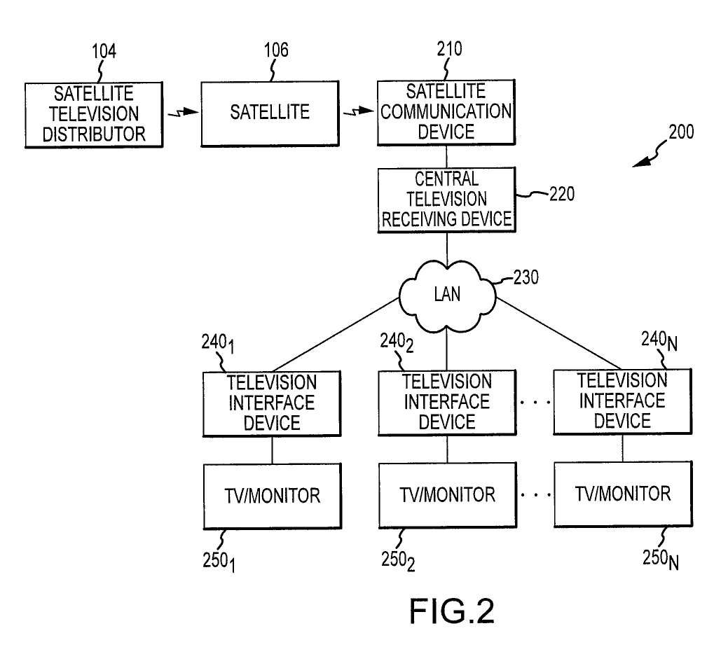

FIG. 2 is a schematic block diagram illustrating an example of a configuration of a system 200 for providing distributed television services to a subscriber. In this example, the subscriber is illustrated as only receiving television signals from the satellite television distributor 104 via the satellite 106, as depicted in FIG. 1. However, it should be understood that the subscriber may, alternatively or additionally, receive television signals from the broadcast television provider 114, and/or the cable television distributor 116 depicted in FIG. 1, or any other suitable source of television signals. As adaptation of the system 200 described herein to various television signal sources will be readily understood, only direct satellite broadcast distribution as the source is described for the sake of clarity.

Thus, similar to the conventional system depicted in FIG. 1, the system 200 may include a satellite communication device 210, such as a satellite dish. The details and operation of the satellite communication device are considered to be well known in the art and thus are not discussed in detail.

In contrast to the conventional system depicted in FIG. 1, the system 200 may include a central television receiving device 220. The central television receiving device 220 may operate as a hub of the system 200, receiving all of the television signals that may be transmitted to a plurality of television output devices, such as televisions or monitors 250₁, 250₂, . . . 250_{N}. Thus, the number of individual television receiving devices 100 associated with the corresponding number of televisions 120, as in FIG. 1, are not needed.

As discussed above, the connections 110, typically provided by coaxial cabling in the conventional system depicted in FIG. 1, are also not needed as the system 200 includes a network 230, such as a local area network, that provides communications between the central television receiving device 220 and the plurality of television output devices, such as televisions or monitors 250₁, 250₂, . . . 250_{N}. Although the network 230 is illustrated in FIG. 2 as a separate component of the system 200, it should be understood that the network 230 may be configured as an element of the central television receiving device 220, such as a networking device that enables the plurality of television output devices to be networked with the central television receiving device 220.

As shown in FIG. 2, the system 200 may include a plurality of television interface devices 240₁, 240₂, . . . 240_{N}, corresponding to the televisions/monitors 250₁, 250₂, . . . 250_{N}. The television interface devices 240₁, 240₂, . . . 240_{N} may be configured to facilitate interaction between the televisions/monitors 250₁, 250₂, . . . 250_{N} and the central television receiving device 220 via the network 230, or networking device of the central television receiving device 220. For example, various models and manufacturers of televisions/monitors may or may not be configured to be directly networked with the system 200. Thus, it may be necessary to provide the television interface devices 240₁, 240₂, . . . 240_{N} to provide suitable functionality. In general however, it should be understood that the television interface devices 240₁, 240₂, . . . 240_{N} may be incorporated into the televisions/monitors 250₁, 250₂, . . . 250_{N}. As such, it should be understood that the plurality of television output devices to be networked with the central television receiving device 220 may be considered to encompass both the televisions/monitors 250₁, 250₂, . . . 250_{N} and the associated television interface devices 240₁, 240₂, . . . 240_{N}, whether separate or integrated.

As described further below, in some embodiments, the television interface devices 240₁, 240₂, . . . 240_{N} may be configured to provide most of the functionality typically provided by conventional television receiving devices, such as conventional set-top-boxes associated with cable and satellite television services. However, the television interface devices 240₁, 240₂, . . . 240_{N} in the system 200 need not include tuners, and may also not include other features such as hard drives and/or smart card inputs, as discussed further below.

In general, the system 200 may provide distributed television service for a subscriber by centralizing the receipt and tuning of television signals at the central television receiving device 220 and transmitting desired television signals to particular television output devices networked with the central television receiving device 220. Thus, the system 200 may take advantage of any known or hereafter developed networking technologies, including wireless networking. For example, wireless Ethernet, IEEE 802.11, wired Ethernet and/or Ethernet using home power wiring may be employed. As such, pre-existing or common wiring for other purposes, such as telephone wiring, power wiring (e.g., wiring for lighting, outlets, and the like), Ethernet wiring, and the like, may be employed rather than coaxial cabling, or no wiring may be employed, thus avoiding many of the drawbacks of coaxial cable or other dedicated wiring based distribution of television service for a subscriber.

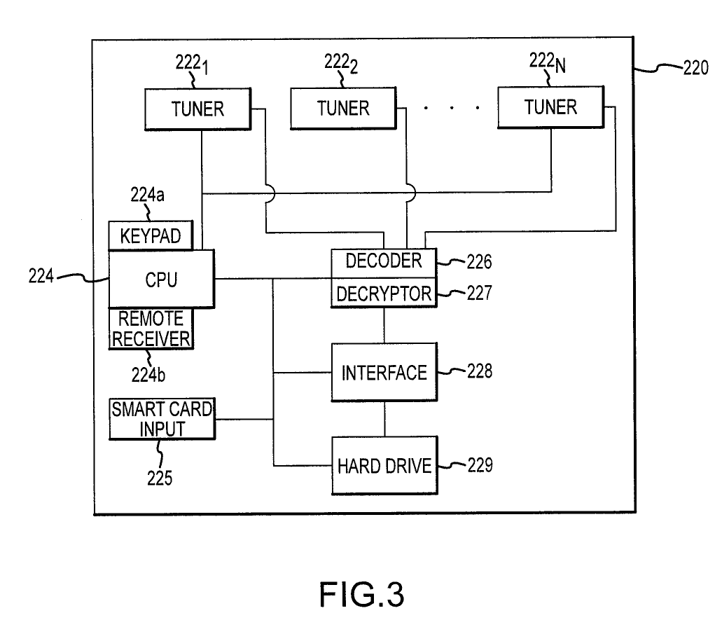

FIG. 3 is a block diagram illustrating an example of the central television receiving device 220 illustrated in FIG. 2. The device 220 may include a plurality of tuners 222₁, 222₂, . . . 222_{N} configured to selectively receive television signals as known in the art. It should be understood that the number of tuners 222 may be determined, for example, based on the size of the system 200 to be implemented or installed. For example, it may be desirable to have two tuners available for each television output device that may be networked to the central television receiving device 220, so that each television output device will be able to have the functionality of watching and/or recording one television signal via one tuner while recording another television signal via another tuner.

However, as each of the tuners 222 may be made available to the various television output devices networked to the central television receiving device 220, fewer tuners 222 may be necessary or desired, depending on the anticipated demands for tuners 222 by the television output devices for viewing and/or recording. It may be envisioned, for example, that a single television output device may be allowed to control or use all tuners not controlled or being used by other television output devices. Thus, if no viewing and/or recording of television signals is occurring via other networked television output devices, all of the tuners 222 of the central television receiving device 220 may be available to the single television output device. Thus, it should be understood that each television output device may request tuner resources and have tuners assigned thereto, and/or the tuners may be “unassigned” and controlled by the central television receiving device 220, for example, with the television output devices requesting television services (e.g., channels, data streams, and the like) and the central television receiving device 220 determining how to provide the requested television services using the tuners 222.

Each of the tuners 222₁, 222₂, . . . 222_{N} may be controlled via a processor 224, such as a CPU or other suitable microprocessor or circuitry. In some embodiments, the processor 224 may include a keypad 224a and/or a remote receiver 224b configured to receive commands from a remote control (not shown). Such user interfaces may allow the system 200 to be configured and reconfigured as appropriate or desired, as described further below.

The central television receiving device 220 may include an interface 228, which may be a wired or wireless interface. The interface 228 may be in communication with the plurality of tuners 222₁, 222₂, . . . 222_{N} to receive television signals therefrom. The interface may be in communication with the processor 224, as appropriate or desired, for controlling the interface 228. As mentioned above, the central television receiving device 220 may communicate with the plurality of television output devices via the network 230. In such case, the interface 228 may be configured to interact with the network 230 to facilitate such communications. As also mentioned above, the central television receiving device 220 may include a networking device to provide the functionality of the network 230 shown in FIG. 2. In such case, the interface 228 may be a networking device.

In either case, the interface 228 may facilitate communications with the plurality of television output devices networked with the central television receiving device 220 so that the plurality of tuners 222₁, 222₂, . . . 222_{N} may be assigned to the plurality of television output devices or otherwise managed to provide requested television services. In some embodiments, the assignment of one or more tuners 220 to each networked television output device may be preset as part of setting up and/or expanding the system 200, for example, using the keyboard 224a and/or the remote control and the remote receiver 224b of the processor 224. In other embodiments, the assignment of one or more tuners 220 to each networked television output device may be based on receipt of a request associated with a particular television output device to tune in a television signal for viewing and/or recording. In such embodiments, the assignment of the tuners 220 to the networked television output devices may be on an “as requested” or “on demand” basis, for example, leaving the tuners available to the various networked television output devices until assigned. In some embodiments, a menu system may be displayed on a television output device so that commands, instructions and/or information may be provided to the processor 224 via the interface 228.

In addition to centralizing the selective reception (tuning) of television signals, the central television receiving device 220 may also centralize other operations and/or functionality that conventionally occur and/or resides in the individual conventional television receiving devices. For example, the central television receiving device 220 may include a smart card input 225 that is configured to receive a smart card, which conventionally may include account information for the subscriber, including authorization, verification and/or other information that enables decoding and/or decrypting of television signals.

Conventionally, encoded and/or encrypted television signals are transmitted via the satellite television distributor to avoid pirating of the television signals by unauthorized users. As such, the television signals received by conventional television receiving devices must be decoded and/or decrypted to be viewed and/or recorded. Thus, each of the conventional television receiving devices depicted in FIG. 1 may include a smart card input for receiving a smart card that includes information that enables decoding and/or decryption of the television signals.

The central television receiving device 220 may allow a single smart card to be used to enable the entire system 200, for example, by including the smart card input 225 as well as any needed software and/or hardware for decoding and/or decrypting, such as a decoder 226 and/or a decryptor 227. By centralizing the decoding and/or decryption, the system 200 may avoid the need for separate smart cards for each television output device to be employed by the subscriber. This may facilitate, for example, reconfiguration of the subscriber's system 200, without the need to activate/deactivate various individual smart cards. For example, updating the information on the subscriber's single smart card that is received in the smart card input 225 of the central television receiving device 220 may allow the number of television output devices networked to the central television receiving device 220 to be increased or decreased as desired.

Other operations and/or functionality that may be centralized by the central television receiving device 220 may relate to recording of television signals, such as for recording television programs such as shows, sports, news movies and the like, pay-per-view programs, or others. Specifically, the central television receiving device 220 may include one or more storage devices, such as a hard drive 229, that is/are controlled via input from the processor 224 and/or from the television output devices via the interface 228. The hard drive(s) 229 may be used to record television signals that may then be accessible via any of the networked television output devices. Thus, including the hard drive(s) 229 in the central television receiving device 220 may provide additional functionality of sharing recordings between networked television output devices.

Alternatively, recordings may be made on the hard drive(s) 229 based on the associated television output device so that only the associated television output device may have access to its recordings. As yet another alternative, various access rights to recordings associated with other television output devices may be defined. For example, parental controls may be implemented by limiting access rights to recordings associated with an adult's television output device. Alternatively, program ratings may be used to restrict access to recordings by a child's television output device.

Other operations and/or functionality may be implemented in the central television receiving device 220, as appropriate or desired. For example, the central television receiving device 220 may be employed for capturing and storing network information, such as a list of services and program guide information. As such, the central television receiving device 220 may provide such information to the television output devices 250 and/or the television interface devices 240 without any need for establishment of a connection to the satellite, cable and/or over-the-air data streams themselves. Additionally or alternatively, the hard drive 229 of the central television receiving device 220 may allow the central television receiving device 220 to serve as a video library of programs recorded as requested by various household users operating the television output devices 250 and/or the television interface devices 240. Additionally or alternatively, the central television receiving device 220 may automatically record informational content, such as videos, and make such content available either as part of a library or as a dynamic extension of help menus that the overall system may employ. Additionally or alternatively, the central television receiving device 220 may include a broadband or other suitable connection (not shown) to facilitate use of the central television receiving device 220, the television output devices 250 and/or the television interface devices 240 remotely, for example, by computers with access to the Internet or an intranet. Additionally or alternatively, the central television receiving device 220 may include a backchannel, such as a telephone line (not shown), to facilitate purchasing pay-per-view content, making television services interactive, and the like.

As discussed above, various operations and/or functionality typically provided by the conventional individual television receiving devices may be centralized by the central television receiving device 220. As also mentioned above, however, certain operations and/or functionality may still be desired at the individual television output devices. Such operations and/or functionality may be implemented, for example, by the television interface devices 240₁, 240₂, . . . 240_{N}.

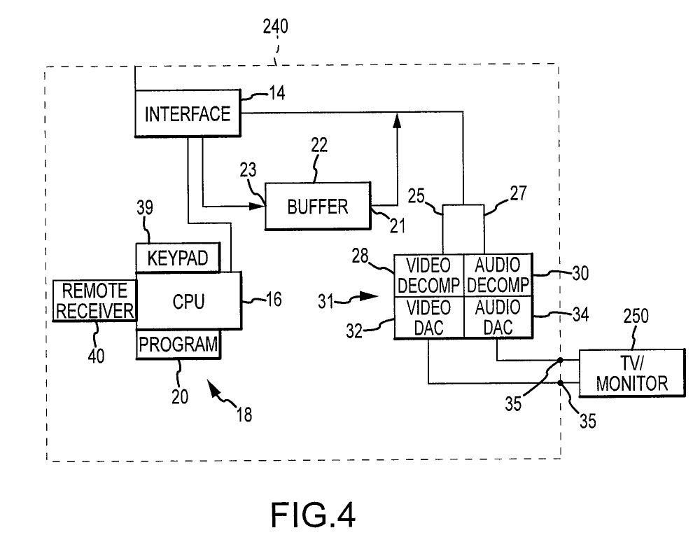

FIG. 4 is a block diagram illustrating an example of a television interface device 240 for interacting with the central television receiving device 220 of FIG. 3. The television interface device 240 may include an interface 14 that is configured to interact with the network 230 and/or the interface 228 of the central television receiving device 220, for example, when the interface 228 is implemented as a networking device. It should be understood that the following description is only illustrative, and that various details are known in the art for implementing various functionality of television receiver devices, such as set-top-boxes, digital video recorders and the like, which may be used to implement the television interface device 240.

The interface 14 may be controlled by a processor 16, such as a CPU or the like, to feed the received television signals to either a buffer 22 or a display decoder 31, depending on the state of a delay program 20. As depicted in FIG. 4, the received television signals may include an audio stream 27 or feed, which may be accepted by an audio decompressor 30 of the display decoder 31, and a video stream 25 or feed, which may be accepted by a video decompressor 28 of the display decoder 31. The audio stream 25 and the video stream 27 may be, for example, fully compliant audio and video program elementary streams as defined by suitable standards.

The video decompressor 28 and the audio decompressor 30 may decompress the video stream 25 and the audio stream 27, respectively, into digital signals. The display decoder 31 may also include a digital to analog converter 32 and a digital to analog converter 34, which may convert the video stream 25 and the audio stream 27, respectively, into analog signals. The resulting baseband analog signals may then be sent to connectors 35 as outputs of the television interface device 240, which may connect to a television or monitor 250.

The buffer 22 may comprise a storage device that may be organized as a queue including a head 21 and a tail 23. The queue may store the signals in a first-in/first-out scheme, such that audio and video signals are passed from the interface 14 to the tail 23, progress through the queue, and are routed from the head 21 to the digital decoder 29. In some embodiments, the buffer 22 may be implemented as one or more high speed hard disks, but any storage device that may be organized as a queue, which has a high storage capacity for audio and video signals, and which operates at acceptable speeds (e.g., solid state, magnetic, circuitry, optical) may be used.

The delay program 20 may comprise an instruction set that manipulates the buffer 22 to delay the presentation of broadcast programming information to a viewer. While the delay program 20 may be implemented through hardware, in some embodiments the delay program 20 may comprise a software program stored in memory 18. Memory 18 may preferably be DRAM, but also may be flash, ferroelectric, or other nonvolatile memory, or conventional RAM with a battery backup. In some embodiments, RAM memory and/or a hard disk drive may be employed.

A user input may be supplied to the television interface device 240, for example, either through a remote control device (not shown) and a remote receiver 40 and/or a keypad 39. The user input may provide desired commands to the CPU 16, such as selecting channels, setting recording timers, interacting with an electronic program guide, or the like.

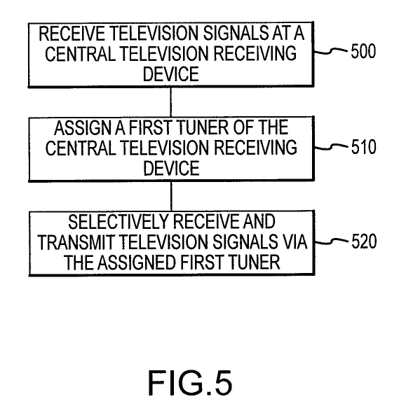

FIG. 5 is a flowchart illustrating an example of operations for providing distributed television services to a subscriber. It should be understood that this flowchart is only an example, and that other methods are envisioned based on the foregoing description. Thus, the method depicted in FIG. 5 should not be considered limiting, or the only implementation of methods that are possible.

Control may begin with operation 500, in which television signals may be received at a central television receiving device. Next, in operation 510, a first of a plurality of tuners of the central television receiving device may be assigned to a corresponding television output device networked to the central television receiving device. As described above, in some embodiments; a plurality of television output devices may be networked to the central television receiving device. Thus, the operation of assigning the first tuner to a corresponding networked television output device may involve selecting or identifying the corresponding networked television output device from the plurality. In some embodiments, such selection or identification may be based on a request by the corresponding television output device to tune in a television signal.

Although not specifically illustrated, it should be understood that control may begin with or include a user request for a television service, for example, via a television output device and/or a television interface device. The request for television service may be transmitted to the central television receiving device, and the first tuner may be assigned as appropriate.

Then, in operation 520, television signals received at the central television receiving device via the assigned first tuner may be selectively received and transmitted to the corresponding television output device and/or television interface device. The selective receiving and transmitting by the assigned first tuner may be in response to control signals from the corresponding television output device, for example, to tune in a particular television signal. In some embodiments, only the data stream for the requested television service may be transmitted. In other embodiments, a multiplexed signal may be transmitted, such as that of a particular transponder in a satellite based system, with the television output device and/or the television interface device demultiplexing or otherwise selecting the particular television service therefrom.

Although not illustrated in FIG. 5, it should be understood from the foregoing that the method may include assigning a second of the plurality of tuners of the central television receiving device to a corresponding second of television output device networked to the central television receiving device. Thus, the method may also include selectively receiving and transmitting television signals received at the central television receiving device via the assigned second tuner to the corresponding second television output device.

Further, the method may include assigning a second tuner of the central television receiving device to the corresponding television output device based on a request by the corresponding television output device to record a television signal other than a television signal tuned in by the assigned first tuner. In other words, based on a demand of the corresponding television output device, additional tuners may be assigned.

Various control methods relating to centralized recording functionality and/or centralized provision of service information and/or program guide data are contemplated and may be implemented as appropriate or desired. For example, when a user wishes to view a recorded event or program, the television output device and/or the television interface device may transmit a request to the central television receiving device for a list of currently saved recordings.

The list may be filtered to take into account permissions granted for the recorded events/programs. For example, each recorded event/program may be restricted to viewing via one or more of the television output devices and/or television interface devices. Alternatively or additionally, each recorded event/program may be restricted to viewing by one or more users, such as by requiring entry of an identifying passcode for operating one or more of the television output device(s) and/or television interface device(s) or accessing the recorded events/programs. Still further, each recorded event/program may be restricted to viewing based on content, channel from which recording was made and/or rating associated with the event or program.

From a menu or display of the list, the user may select an event/program using the television output device and/or the television interface device. A corresponding command may be transmitted from the television output device and/or the television interface device to the central television receiving device to cause the selected event/program to be transmitted from the central television receiving device to the television output device. In some embodiments, the selected event/program may be directly transmitted, such as by streaming, with viewing control implemented at the central television receiving device based on commands from the television output device and/or the television interface device, such as pause, fast forward, skip forward, rewind and the like. In other embodiments, the selected event/program may be provided, for example, to the television interface device in whole or in part and stored temporarily for viewing control at the television interface device. This may be implemented, for example, by a local buffer for time-shifting.

Although various details have been described herein with reference to particular embodiments, it is to be understood that these embodiments are merely illustrative of principles and applications. It is therefore to be understood that numerous modifications may be made to the illustrative embodiments and that other arrangements may be devised without departing from the spirit and scope of this disclosure.

What is claimed is:

1. A system for providing distributed television service to a subscriber, the system comprising:
a central television receiving device configured to selectively receive television signals to be distributed to a plurality of television output devices based on commands from the plurality of television output devices; and
a networking device configured to interface the central television receiving device with the plurality of television output devices to transmit commands from individual ones of the plurality of television output devices to the central television receiving device and to selectively transmit video to the individual ones of the plurality of television output devices from the central television receiving device.

2. The system of claim 1, wherein the central television receiving device includes a plurality of tuners, each of the plurality of tuners configured to be controlled based on signals received via the networking device.

3. The system of claim 2, wherein the central television receiving device includes at least one storage device in communication with the plurality of tuners.

4. The system of claim 1, wherein the central television receiving device includes a smart card input configured to receive information based on which the central television receiving device is configured to at least one of decode and decrypt the received television signals.

5. The system of claim 1, wherein the networking device comprises a wireless networking device.

6. The system of claim 1, wherein the networking device comprises an Ethernet device.

7. The system of claim 1, wherein the networking device is configured to communicate with the plurality of television output devices via telephone wiring.

8. The system of claim 1, wherein the networking device is configured to communicate with the plurality of television output devices via power wiring.

9. A central television receiving device for providing distributed television service to a subscriber, the device comprising:
a plurality of tuners configured to selectively receive television signals;
a processor configured to control the plurality of tuners; and
a networking device configured to interface the plurality of tuners with a plurality of television output devices to transmit commands received from individual ones of the plurality of television output devices to the processor and to selectively transmit video from individual ones of the plurality of tuners to the individual ones of the plurality of television output devices.

10. The device of claim 9, wherein the plurality of tuners are configured to be controlled based on signals received via the networking device.

11. The device of claim 9, further comprising a smart card input in communication with the processor, the smart card input configured to receive information based on which processor is configured to at least one of decode and decrypt the received television signals.

12. The device of claim 9, wherein the networking device comprises a wireless networking device.

13. The device of claim 9, wherein the networking device comprises an Ethernet device.

14. The device of claim 9, wherein the networking device is configured to communicate with the plurality of television output devices via telephone wiring.

15. The system of claim 9, wherein the networking device is configured to communicate with the plurality of television output devices via power wiring.

16. A method of providing distributed television service to a subscriber, the method comprising:
receiving television signals at a central television receiving device;
assigning a first of a plurality of tuners of the central television receiving device to a corresponding one of a plurality of television output devices in communication with the central television receiving device via a network; and
selectively receiving and transmitting television signals received at the central television receiving device via the assigned first tuner to the corresponding television output device via the network based on commands received at the central television receiving device from the corresponding television output device via the network.

17. The method of claim 16, wherein the assigning of the first tuner to the corresponding television output device is based on a request by the corresponding television output device to tune in a television signal.

18. The method of claim 16, further comprising:
assigning a second of the plurality of tuners of the central television receiving device to a corresponding second of the plurality of television output devices in communication with the central television receiving device via the network; and
selectively receiving and transmitting television signals received at the central television receiving device via the assigned second tuner to the corresponding second television output device via the network based on commands received at the central television receiving device from the corresponding second television output device via the network.

19. The method of claim 16, further comprising:
assigning a second of the plurality of tuners of the central television receiving device to the corresponding television output device based on a request by the corresponding television output device to record a television signal other than a television signal tuned in by the assigned first tuner.

20. The method of claim 19, further comprising at least one of decoding and decrypting the television signals at the central television receiving device.
